(19) United States
(12) Patent Application Publication
(10) Pub. No.: US 2015/0021317 A1
(43) Pub. Date: Jan. 22, 2015

(54) LATCH AND A COLLAPSIBLE CONTAINER COMPRISING THE SAME

(71) Applicant: REES OPERATIONS PTY LTD, Adelaide (AU)

(72) Inventors: Ian Sharkey, Adelaide (AU); Matthew Reimers, Adelaide (AU); David Need, Adelaide (AU)

(21) Appl. No.: 14/382,819

(22) PCT Filed: Mar. 8, 2013
(86) PCT No.: PCT/AU2013/000239

§ 371 Date: Sep. 4, 2014

(30) Foreign Application Priority Data
Mar. 9, 2012 (AU) 2012900961
Apr. 24, 2012 (AU) 2012901617

(51) Int. Cl. B65D 88/52; B65D 43/14; E05C 19/14

(52) U.S. Cl. CPC B65D 88/52; E05C 19/14; B65D 43/14
USPC 220/4.01; 292/340; 292/96

(57) ABSTRACT

This invention relates to a latch assembly for use in securing panels and/or gates of materials handling containers in their erected positions. The latch assembly comprises a latch keeper and a separate latch assembly body, a latch depending from the latch assembly body, and a latch actuator depending from the latch assembly body and operatively associated with the latch, wherein said latch comprises means for grappling the latch keeper and securing this relative to the latch assembly body. Also disclosed is an associated method for operating the latch assembly, a materials handling container, and a panel or gate therefor.

### FIELD OF THE INVENTION

The present invention relates a latch assembly for use in securing panels and/or gates of collapsible materials handling containers in their erected positions.

### PRIORITY

This patent application claims priority from:
Australian Provisional Patent Application No 2012900961, titled “COMBINED MONKEY GRIP AND POLY RETENTION SYSTEM”, and filed on 9 Mar. 2012; and
Australian Provisional Patent Application No 2012901617, titled “CONTAINER LATCH”, and filed on 24 Apr. 2012.

The entire content of these applications is hereby incorporated by reference.

### BACKGROUND

Collapsible containers having side and end panels and/or gates which are securable to the container base so as to be movable between upright erected positions and collapsed positions wherein they lie in flat atop of the base, are known in the materials handling industry.

Many different types of connections between the panels and the base have been utilised, including both pivotal attachments there between (so that the panels form gates), as well as detachable connections which allow the panels to be physically separated from the base if required.

When the panels/gates are erect, generally the opposite vertical perimeter frame members on one panel respectively are adjacent inner faces of an adjacent panel or gate, with adjacent panels or gates being interlocked by means of manually releasable locking or latching mechanisms which are normally located at the top corners of the panels and which, when in their locking conditions, lock the adjacent panels relative to each other in their upright positions.

The materials handling industry is extremely competitive and one of the prime design factors for manufacturers of collapsible containers is the fabrication costs and the need to reduce the cost of manufacture wherever possible.

It is against this background that the present invention has been developed.

Certain objects and advantages of the present invention will become apparent from the following description, taken in connection with the accompanying drawings, wherein, by way of illustration and example, an embodiment of the present invention is disclosed.

### SUMMARY OF THE INVENTION

In one aspect, the invention may be said to reside in a latch assembly comprising a latch keeper and a separate latch assembly body, a latch depending from the latch assembly body, and a latch actuator depending from the latch assembly body and operatively associated with the latch, wherein said latch comprises means for grappling the latch keeper and securing this'relative to the latch assembly body.

In one form, the latch and latch keeper each comprise means shaped for complementary engagement thereof.

In one form, the latch keeper comprises means for catching the grappling means of the latch.

In one form, the latch comprises a head at or toward one end thereof, said head forming a grappling hook portion (ie. the grappling means) for grappling the latch keeper.

In one form, the latch assembly body depends from a gate of a collapsible storage container.

In one form, the latch keeper is a portion of an adjacent gate of the collapsible storage container.

In one form, in an alternative, the latch keeper is an attachment for an adjacent gate of the collapsible storage container.

In use, the latch has a first range of movement extending between a stowed position and a reaching position, and a further range of movement extending between the reaching position and a grappling (ie. latching or capture) position.

In use, the latch actuator has a range of movement ranging extending between a position effecting latch reaching, and a latched and stowed position.

In one form, the latch actuator is a lever.

In one form, the latch is stowed within the latch actuator.

In one form, the latch actuator is stowed within the latch assembly body.

In one form, latch is stowed within the latch assembly body.

In a further aspect, the invention may be said to reside in a latch assembly comprising a latch assembly body, a latch actuator depending from the latch assembly body, a latch depending from the latch assembly body and operatively associated with the latch actuator, and a latch keeper separate from the latch assembly body, wherein said latch is movable between a latching position and a stowed position in which the latch is stowed within the latch assembly body along with the latch actuator.

In one form, the latch assembly further comprises means for locking the latch in either of its latched or stowed positions.

In one form, the locking means comprises a locking pin.

In a further aspect, the invention may be said to reside in a method of operation of the above described latch assembly to effect latching, the method comprising the steps of driving the latch into its reaching position, and then driving from this reaching position into its grappling position with respect to the keeper.

In one form, the latch is driven into its reaching position by movement of the latch actuator from its stowed position to a position effecting latch reaching.

In a further aspect, the invention the may be said to reside in a storage container comprising a base, two pairs of opposing side and end panels and/or gates, wherein when the panels and/or gates are erect, a vertical margin of a side panel and/or gate is adjacent a vertical margin of an end panel and/or gate, the container further comprising a latch assembly as described above, for securing the vertical margins of the adjacent side and end panels and/or gates in an abutting status.

In one form, a first panel and/or gate from the pair of adjacent side and end panels and/or gates comprises a latch assembly body, latch and latch actuator, and the second, adjacent panel and/or gate comprises an operatively associated latch keeper.

In one form, the storage container further comprises a lid, and a further latch assembly for securing the lid to one of the side or end panels and/or gates.

In a further aspect, the invention the may be said to reside in a panel or gate for a storage container, the panel or gate comprising a latch assembly body, latch and latch actuator from the latch assembly described above.

In one form, the panel or gate comprises opposing vertical margins, and the latch assembly body, latch and latch actuator are associated with one of the vertical margins.

In a further aspect, the invention the may be said to reside in a panel or gate for a storage container, the panel or gate comprising a latch keeper of the latch assembly described above.

In one form, the panel or gate comprises opposing vertical margins, and the latch keeper is associated with one of the vertical margins.

In a further aspect, the invention the may be said to reside in a lid for a storage container, the lid comprising either of a latch keeper of the latch assembly described above, or a latch assembly body, latch and latch actuator from the latch assembly.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF THE DRAWINGS

For a better understanding of this disclosure it will now be described with respect to an exemplary embodiment which shall be described herein with the assistance of drawings wherein:

FIGS. 1 and 2 are perspective views of a collapsible storage container comprising latch assemblies;

FIG. 3 is an end view of the collapsible storage container of FIGS. 1 and 2;

FIG. 4 is a detail view of the latch at position C of FIG. 3;

FIG. 5 is a detail view of the latch at position D of FIG. 2;

FIG. 6 is a detail view of the latch at position B of FIG. 1;

FIG. 7 is a detail view of the latch at position A of FIG. 2;

FIG. 8 is a cross-sectional view taken through the latch along line E-E of FIG. 3; and

FIG. 9 is a cross-sectional view taken through the latch along line F-F of FIG. 3.

In the following description, like reference characters designate like or corresponding parts throughout the several views of the drawings.

### DETAILED DESCRIPTION OF AN EMBODIMENT OF THE INVENTION

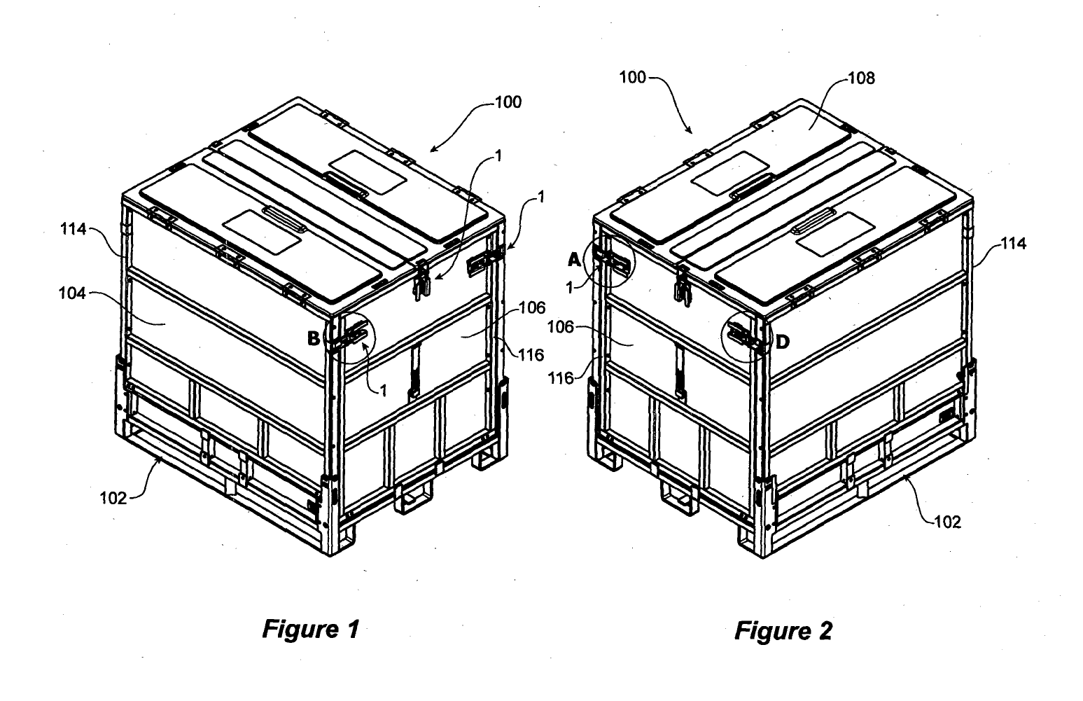

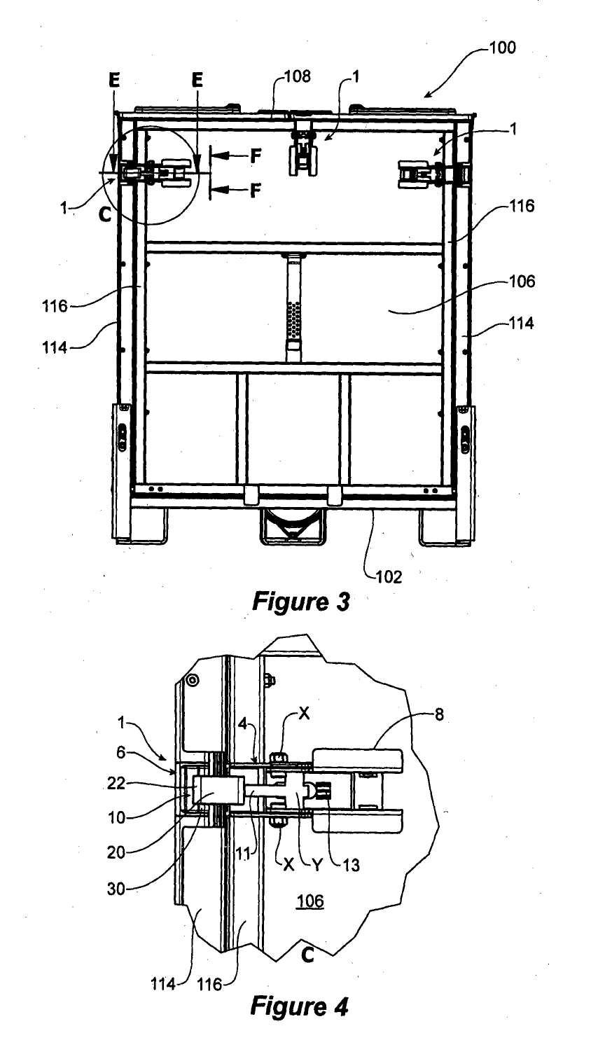

Referring now to FIGS. 1 and 2, where, for the purpose of explanation, the latch assembly 1 is illustrated employed in a collapsible storage container 100. This collapsible storage container comprises a base 102, and two pairs of opposing side and end gates 104 and 106 respectively.

The side and end gates 104 and 106 are pivotally attached to the base 102 for folding movement between upright erected positions and collapsed positions wherein they lie in a flat condition on top of the base 102 and each other.

When the gates are erect, a vertical perimeter frame member 114 of a side gate 104 lies adjacent a vertical perimeter frame member 116 of an end gate 106. The latch assembly 1 then is used to secure the vertical perimeter frame members of the respective side and end gates 114 and 116 in an erect and abutting status, and prevent separation of these gates.

One or more further latch assemblies 1 can be further employed for the purpose of securing a container lid 108 to the assembled collapsible storage container 100. Such usage demonstrates how applications for the latch are not limited to collapsible storage containers.

Referring now to FIGS. 4 through 9, a latch assembly body 4 of the latch assembly 1 depends from an outer side of an end gate 106, and a latch keeper 6, or a portion shaped to act as a keeper, depends from a side gate 104, although this order could be reversed.

In this exemplary embodiment, the latch keeper 6 is formed so as to have a generally cuboid outer shape, and have upper and lower extension portions for insertion into the tubular steel members from which the vertical perimeter frame members 114 of the side gate 104.

The latch assembly body 4 defines an elongate and outwardly opening channel (hereinafter the body channel). Nested in this body channel and pivotally connected to the latch assembly body 4 is a latch actuator 8 in the form of a lever which defines its own elongate and outwardly opening channel (hereinafter the lever channel). When stowed, this lever 8 extends from its pivotal attachment point X with the latch assembly body 4 in a direction away from the keeper 6.

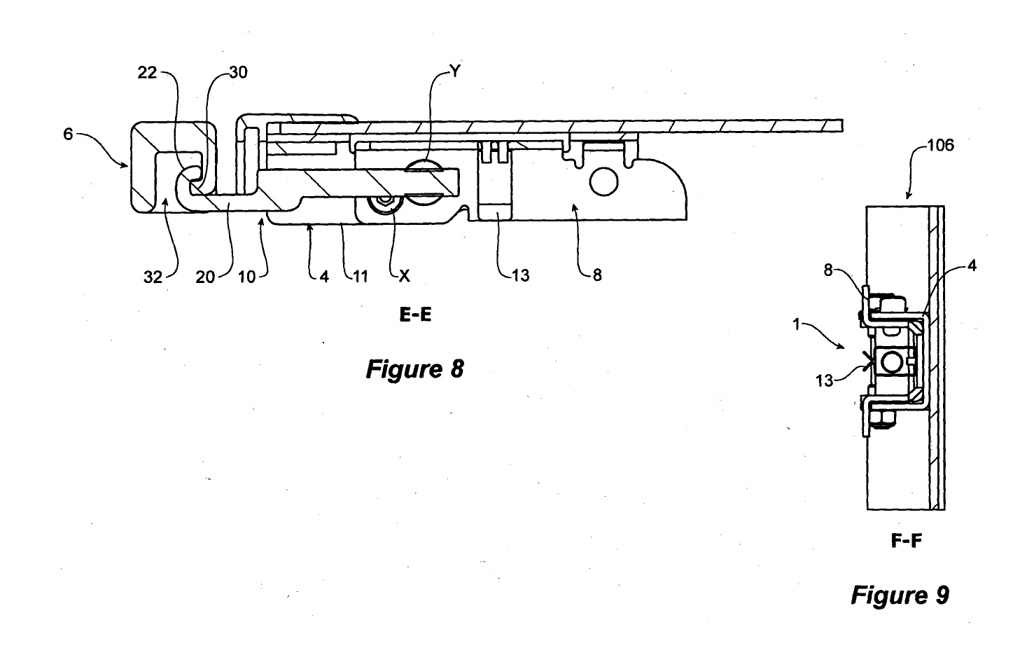

Nested in the lever channel and pivotally connected to the lever 8 is a latch 10. In use, the latch 10 extends from its pivotal attachment point Y (see FIG. 8) with the lever (ie. the latch actuator) 8 in a direction toward the keeper 6.

The latch 10 and latch keeper 6 each comprise means shaped for complementary engagement thereof; the latch 10 comprising means for grappling (i.e. seizing and securing) the latch keeper 6, and the latch keeper 6 comprising means for catching the grappling means of the latch 10.

Distal from its pivotal attachment point Y, the latch 10 comprises a head 20 forming a grappling hook portion 22 (ie. the grappling means—see FIG. 8) for grappling a catching flange 30 (ie. the catching means) depending from the keeper 6.

The pivotal attachment point Y for the latch 10 is further from the latch keeper 6 than is the pivotal attachment point X for the lever 8, creating an over-centre latching arrangement which provides a mechanical advantage to the user.

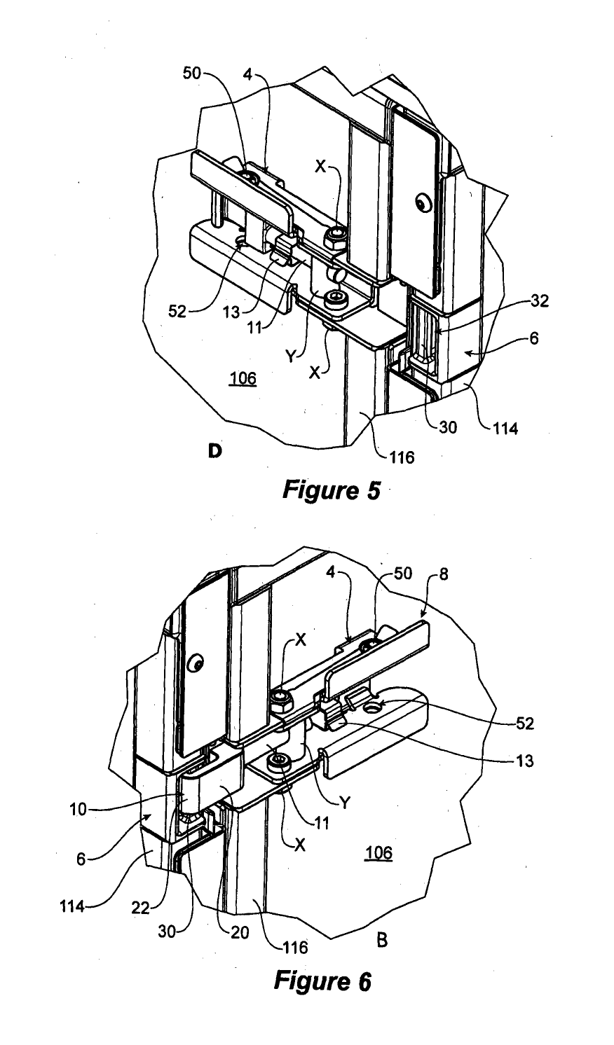

When not in use, the latch 10 is flipped about its pivotal attachment point X with the lever 8 so that the head 20 of the latch 10 is directed away from the keeper 6, as illustrated in FIG. 5. The latch 10 can then be stowed by nesting in the lever channel, and a neck 11 of the latch 10 captured in a retaining clip 13, as illustrated in FIG. 5. The lever 8 in turn, is stowed by nesting in the latch body assembly channel.

Stowing the latch 10 in this fashion protects latch 10 and lever 8 from damage when these are not required, such as when the container 100 is collapsed for return shipment.

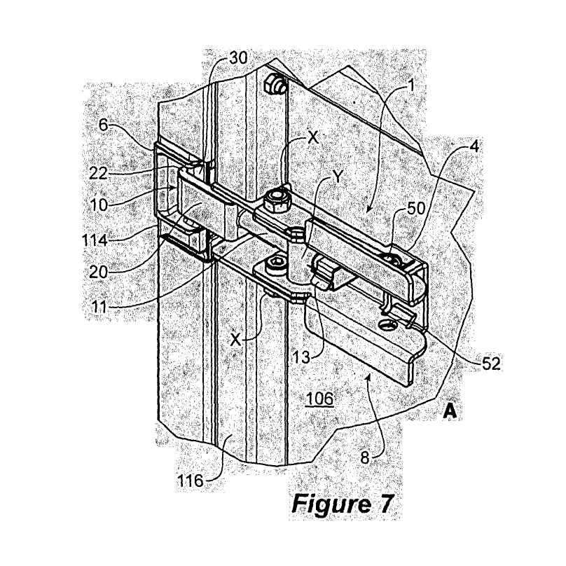

When required, the latch 10 is again flipped about its pivotal attachment point Y with the lever 8, so that the head 20 of the latch 10 is directed toward the keeper 6, as illustrated in FIGS. 6 and 7.

The latch 10 is then actuated by rotation of the lever 8 about its pivotal attachment point X until the lever 8 extends out of the latch assembly body 4, this movement of the lever 8 permitting the pivotal attachment point Y for the latch 10 to move toward the keeper 6, permitting the grappling hook portion 22 of the head 20 of the latch 10 to reach beyond catching flange 30 of the latch keeper 6 (i.e. move to a reaching position) into a receiving port 32 (best seen in FIG. 8) for the grappling hook portion 22 that is formed into the latch keeper 6.

The grappling hook portion 22 of the head 20 of the latch 10 can then be driven into engagement with catching flange 30 by returning the lever 8 to its stowed position.

The latch 10 can be locked in its latched position by use of a locking pin 50 inserted through aligned apertures 52 in each of the lever 8 and the latch assembly body 4. Locking pin 50 can also be employed in the same way to lock the latch 10 in its stowed position.

The latch 10 is released and then stowed by reversing the above described process.

It will be apparent from the above that the latch assembly 1 according to the present invention provides a positive capture and secure interlocking of even somewhat misaligned container gates, with a quick, easy action that also provides a mechanical advantage to the user and prevents separation of the gates. Moreover, latch assembly 1 also neatly, compactly and securely stows when not in use, so as to protect key components thereof from damage.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications in its scope.

1. A latch assembly comprising a latch keeper and a separate latch assembly body, a latch depending from the latch assembly body, and a latch actuator depending from the latch assembly body and operatively associated with the latch, wherein said latch comprises means for grappling the latch keeper and securing this relative to the latch assembly body.

2. The latch assembly of claim 1, wherein the latch and latch keeper each comprise means shaped for complementary engagement thereof.

3. The latch assembly of claim 1, wherein the latch keeper comprises means for catching the grappling means of the latch.

4. The latch assembly of claim 1, wherein the latch comprises a head at or toward one end thereof, said head forming a grappling hook portion for grappling the latch keeper.

5. The latch assembly of claim 4, wherein the catching means comprises a receiving port for receiving the grappling hook portion, and a catching flange for catching the grappling hook portion.

6. The latch assembly of claim 1, wherein the latch has a first range of movement extending between a stowed position and a reaching position, and a further range of movement extending between the reaching position and a grappling position.

7. The latch assembly as in claim 6, wherein the latch actuator has a range of movement extending between a position effecting latch reaching, and a latched and stowed position.

8. The latch assembly of claim 7, wherein the latch is stowed within the latch assembly body along with the latch actuator.

9. The latch assembly of claim 8, wherein the latch is stowed within the latch actuator, and the latch actuator is stowed within the latch assembly body.

10. A method of operation of the latch assembly of claim 6 to effect latching, the method comprising the steps of driving the latch into its reaching position, and then driving the latch from this reaching position into its grappling position with respect to the keeper.

11. The method of claim 10, wherein the latch is driven into its reaching position by movement of the latch actuator from its stowed position to a position effecting latch reaching.

12. The method of claim 10, wherein the latch is driven into its grappling position by movement of the latch actuator from its position effecting latch reaching to its latched and stowed position.

13. A storage container comprising a base, two pairs of opposing side and end panels and/or gates, wherein when the panels and/or gates are erect, a vertical margin of a side panel and/or gate is adjacent a vertical margin of an end panel and/or gate, the container further comprising a latch assembly according to claim 1, for securing the vertical margins of the adjacent side and end panels and/or gates in an abutting status.

14. The storage container of claim 13, wherein a first panel and/or gate from the pair of adjacent side and end panels and/or gates comprises a latch assembly body, latch and latch actuator, and the second, adjacent panel and/or gate comprises an operatively associated latch keeper.

15. The storage container of claim 13, wherein the storage container further comprises a lid, and a further latch assembly for securing the lid to one of the side or end panels and/or gates.

16. A panel or gate for a storage container, the panel or gate comprising a latch assembly body, latch and latch actuator from the latch assembly of claim 1.

17. The panel or gate of claim 16, wherein the panel or gate comprises opposing vertical margins, and the latch assembly body, latch and latch actuator are associated with one of the vertical margins.

18. A panel or gate for a storage container, the panel or gate comprising a latch keeper of the latch assembly of claim 1.

19. The panel or gate of claim 18, wherein the panel or gate comprises opposing vertical margins, and the latch keeper is associated with one of the vertical margins.

20. A lid for a storage container, the lid comprising either of a latch keeper of the latch assembly of claim 1, or a latch assembly body, latch and latch actuator from the latch assembly.
